(19) United States
(12) Patent Application Publication
(10) Pub. No.: US 2003/0093287 A1
(43) Pub. Date: May 15, 2003

(54) Method and apparatus for facilitating communication regarding a customer

(76) Inventor: Thomas Tyson Lowery, Stamford, CT (US)

Correspondence Address: BUCKLEY, MASCHOFF, TALWALKAR, & ALLISON, 5 ELM STREET, NEW CANAAN, CT, 06840, US

(21) Appl. No.: 10/061,129

(22) Filed: Nov. 13, 2001

(51) Int. Cl. G06F 17/60

(52) U.S. Cl. 705/1

(57) ABSTRACT

A system, method, apparatus, means, and computer program code for facilitating communication between one or more referral sources and one or more service providers. A party or device implementing the methods disclosed herein may receive leads or other information from a referral source, create a lead from information received from a referral source, provide some or all of the information to a service provider, and receive updates to the lead or information from the service provider. The party or device may implement a Web site to coordinate activities between referral sources and service providers.

### FIELD OF THE INVENTION

The present invention relates to a method and apparatus for facilitating communication regarding a customer and, more particularly, embodiments of the present invention relate to methods, means, apparatus, and computer program code for centralizing information regarding customer leads and additional activities taken with customers as a result of such leads.

### BACKGROUND OF THE INVENTION

As part of a conventional sales and marketing strategy, a company may use telemarketers, call centers, marketing agents etc. to generate leads for the company. A lead may indicate a contact name, address, telephone number, etc. of a potential customer A salesperson or other representatives of the company may then contact the potential customer or otherwise follow up with the potential customer.

In some prior art systems, a business may operate a referral center, network, World Wide Web (“Web”) site, or other device or entity which a customer may contact or otherwise interact with to look for information regarding one or more services the customer is interested in receiving or learning more about. The customer may then provide information to the device or entity and/or request that the device or entity forward information regarding the customer onto one or more service providers. For example, the Web site provided at www.powerbuyerservice.com allows a customer to select one or more service providers that the customer is interested in learning about and then informs the relevant service providers of the customer's interest. At this point, the Web site has limited, if any, ability to track use of the information by the service providers. In addition, requests from the Web site to a service provider is dependent on the request of a customer.

It would be advantageous to provide a method and apparatus that overcame the drawbacks of the prior art. In particular, it would be desirable to provide a resource that facilitated communication between multiple parties regarding customer information, customer leads, etc. and improved ability to track use of customer information by service providers.

### SUMMARY OF THE INVENTION

Embodiments of the present invention provide a system, method, apparatus, means, and computer program code for facilitating communication among multiple parties regarding customer information, customer leads, etc. According to embodiments of the present invention, information regarding a customer or potential customer may be received from a customer or a party other than the customer (e.g., telemarketers, mail-in inquiries). The information may be used to create a customer lead regarding what kind of services may be applicable to the customer or of use to the customer.

Additional objects, advantages, and novel features of the invention shall be set forth in part in the description that follows, and in part will become apparent to those skilled in the art upon examination of the following or may be learned by the practice of the invention.

According to embodiments of the present invention, a method for facilitating multiparty communication regarding leads may include receiving initial information regarding a customer lead from a first party; identifying a second party to which to provide at least a portion of the initial information; providing at least a portion of the initial information to the second party; receiving updated information regarding the customer lead from the second party; and determining compensation owed by the second party based, at least in part, on the updated information. In another embodiment, a method for facilitating multiparty communication regarding leads may include receiving initial information regarding a first customer from a first party; identifying a second party to which to provide a notice regarding availability of at least a portion of the initial information; providing the notice to the second party; allowing the second party to access at least a portion of the initial information; and receiving updated information regarding the first customer from the second party. In a further embodiment, a method for facilitating access to information regarding at least one customer may include facilitating creation of a first lead based, at least in part, on information regarding a customer; facilitating identification of a first party which will be allowed to access the first lead; providing a notice to the first party regarding availability of access to the first lead; and allowing the first party to access the first lead. In yet another embodiment, a method for facilitating access to information regarding at least one customer may include allowing a first party to create a lead regarding a customer; allowing the first party to identify a second party to which to provide the lead; providing notice to the second party regarding availability of the lead; allowing the second party to access the lead; and receiving updated information from the second party regarding the customer.

According to embodiments of the present invention, a system for facilitating access to customer information may include a memory; a communication port; and a processor connected to the memory and the communication port, the processor being operative to receive initial information regarding a customer lead from a first party; identify a second party to which to provide at least a portion of the initial information; provide at least a portion of the initial information to the second party; receiving updated information regarding the customer lead from the second party; and determine compensation owed by the second party based, at least in part, on the updated information. In another embodiment, a system for facilitating access to customer information may include a memory; a communication port; and a processor connected to the memory and the communication port, the processor being operative to receive initial information regarding a first customer from a first party; identify a second party to which to provide a notice regarding availability of at least a portion of the initial information; provide the notice to the second party; allow the second party to access the at least a portion of the initial information; and receive updated information regarding the first customer from the second party. In a further embodiment, a system for facilitating access to customer information may include a memory; a communication port; and a processor connected to the memory and the communication port, the processor being operative to facilitate creation of a first lead based, at least in part, on information regarding a customer; facilitate identification of a first party which will be allowed to access the first lead; provide a notice to the first party regarding availability of access to the first lead; and allow the first party to access the first lead. In yet another embodiment a system for facilitating access to customer information may include a memory; a communication port; and a processor connected to the memory and the communication port, the processor being operative to allow a first party to create a lead regarding a customer; allow the first party to identify a second party to which to provide the lead; provide notice to the second party regarding availability of the lead; allowing the second party to access the lead; and receive updated information from the second party regarding the customer.

According to embodiments of the present invention, a computer program product in a computer readable medium for facilitating multiparty communication regarding leads may include first instructions for obtaining initial information regarding a customer lead from a first party; second instructions for determining an identity a second party to which to provide at least a portion of the initial information; third instructions for sending at least a portion of the initial information to the second party; fourth instructions for obtaining updated information regarding the customer lead from the second party; and fifth instructions for calculating compensation owed by the second party based, at least in part, on the updated information. In another embodiment, a computer program product in a computer readable medium for facilitating multiparty communication regarding leads may include first instructions for obtaining initial information regarding a first customer from a first party; second instructions of determining an identify of a second party to which to provide a notice regarding availability of at least a portion of the initial information; third instructions for sending the notice to the second party; fourth instructions of providing by the second party to access the at least a portion of the initial information; and fifth instructions for obtaining updated information regarding the first customer from the second party. In a further embodiment, a computer program product in a computer readable medium for facilitating exchange of customer information may include first instructions for generating a lead based, at least in part, on information regarding a customer; second instructions identifying a first party which will be allowed to access the lead; third instructions for sending a notice to the first party regarding availability of access to the lead; and fourth instructions for providing access the lead by the first party. In yet another embodiment, a computer program product in a computer readable medium for facilitating multiparty communication regarding leads may include first instructions for assisting a first party to create a lead regarding a customer; second instructions for assisting the first party to identify a second party to which to provide the lead; third instructions for sending notice to the second party regarding availability of the lead; fourth instructions for assisting the second party to access the lead; and fifth instructions for sending updated information from the second party regarding the customer.

According to embodiments of the present invention, an apparatus for facilitating multiparty communication regarding leads may include means for obtaining initial information regarding a customer lead from a first party; means for determining an identity a second party to which to provide at least a portion of the initial information; means for sending at least a portion of the initial information to the second party; means for obtaining updated information regarding the customer lead from the second party; and means for calculating compensation owed by the second party based, at least in part, on the updated information. In another embodiment, an apparatus for facilitating multiparty communication regarding leads may include means for obtaining initial information regarding a first customer from a first party; means for determining an identify of a second party to which to provide a notice regarding availability of at least a portion of the initial information; means for sending the notice to the second party; means for providing by the second party to access the at least a portion of the initial information; and means for obtaining updated information regarding the first customer from the second party. In a further embodiment, an apparatus for facilitating exchange of customer information may include means for generating a lead based, at least in part, on information regarding a customer; means identifying a first party which will be allowed to access the lead; means for sending a notice to the first party regarding availability of access to the lead; and means for providing access the lead by the first party. In yet another embodiment, ant apparatus for facilitating multiparty communication regarding leads may include means for assisting a first party to create a lead regarding a customer; means for assisting the first party to identify a second party to which to provide the lead; means for sending notice to the second party regarding availability of the lead; means for assisting the second party to access the lead; and means for sending updated information from the second party regarding the customer.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a flowchart of a third embodiment of a method in accordance with the present invention;

FIG. 4 is a flowchart of a fourth embodiment of a method in accordance with the present invention;

FIG. 5 is a block diagram of system components for an embodiment of an apparatus usable with the methods of FIGS. 1-4;

FIG. 6 is a block diagram of components for an embodiment of a device used by the coordinator of FIG. 5;

FIG. 7 is an illustration of a representative customer information database of FIG. 6;

FIG. 8 is an illustration of a representative service information database of FIG. 6; and

FIG. 9 is an illustration of a representative lead information database of FIG. 6.

### DETAILED DESCRIPTION

Applicants have recognized that there is a need for systems, means and methods that facilitates communication between parties regarding customers, customer leads, etc.

As will be illustrated by the examples and description provided below, a party or device implementing the methods disclosed herein may receive leads or other information from a referral source (e.g., telemarketer, salesperson, property manager, asset manager), create a lead from information received from a referral source, provide some or all of the information to a service provider, and receive updates to the lead or information from the service provider. The party or device may implement a Web site to coordinate activities between referral sources and service providers. Access to the Web site, different parts of the Web site, different leads or customer information, etc. may be password protected.

The Web site may allow a referral source to view, sort, and/or update information or leads provided by the referral source. Similarly, the Web site may allow a service provider to view, sort and/or update information or leads provided to the service provider. In some embodiments, a service provider may not be able to see leads, notices or other information provided by the Web site to other service providers. Similarly, a referral source may be limited to viewing, sorting, updating, etc. only that information provided by the referral source.

Updated information from a service provider regarding a customer or customer lead may indicate what actions the service provider has taken as a result of the customer lead or with the customer, the status of a lead or customer interaction (e.g., follow up meeting scheduled, service provider information sent to the customer, customer has purchased services, follow up telephone contact planned), the status or details of one or more transactions between the service provider and the customer, etc. The Web site also may include a service provider information database or wizard to allow referral sources to determine what service providers may be relevant or of interest to specific customers or customer leads.

The Web site may determine compensation due, or receive compensation, from a service provider for acting as a clearinghouse of referrals, for making referrals to the service provider, etc. In addition, the Web site may determine what, if any, compensation should be provided to referral sources for providing or generating customer leads and other information.

In some embodiments, leads or other information may use different names for the same customer. For example, a customer may be designated as “GEC Apartment Management” in one lead and as “GEC, Inc.” in another lead. The methods and devices described herein may allow records to be merged such that the name or other field entry for one customer are changed. For example, all records in a database that identify a customer as “GEC, Inc.” may be changed so that the company is named “GEC Apartment Management” instead.

As used herein the term “service” shall include products as well as services. Thus, a service provider may include any business, company, person, or entity that provides, distributes, licenses or sells one or more products and/or services.

Process Description

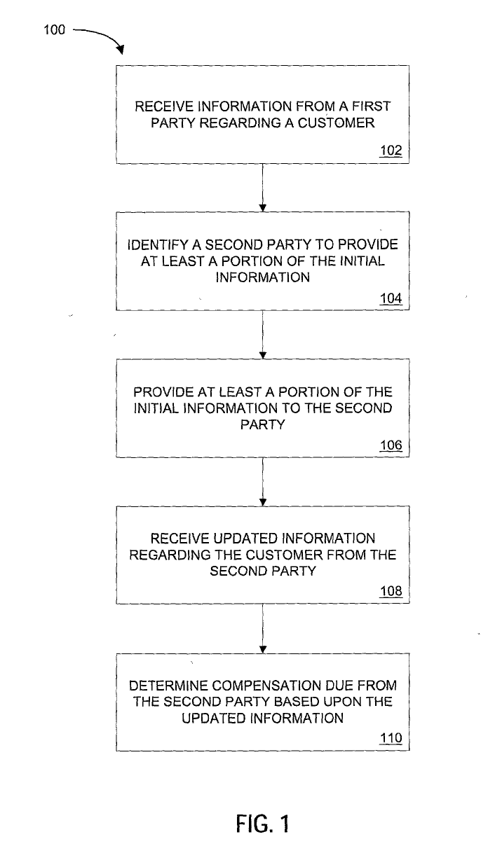

Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a server, user device and/or another device, as will be discussed in more detail below.

The method 100 is particularly suited for a coordinator or central resource (e.g., Web site, server) that receives information regarding customers and provides some or all of the information to one or more service providers. In some embodiments, the coordinator or central resource may provide leads to service providers in more than one industry classification. Similarly, in some embodiments, the coordinator or central resource may provide leads to one or more service providers in a limited or designated geographic area. In other embodiments, the coordinator or central resource may work only with service providers having a regional or national presence.

Processing begins at a step 102 during which information is received from a first party regarding a customer. The first party may be a referral source such as a call or information center that receives or takes calls from customers or potential customers, telemarketing facility that does in-bound and/or out-bound calling, salesperson, marketing agent or representative, service provider, etc. The first party may generate the information received during the step 102 as a result of an interaction between the first party and a customer. For example, a roofing company may hire a telemarketing company to contact potential customers on its behalf. The telemarketing company may provide the information that is received during the step 102. As another example, the roofing company may be doing work for a business that also needs carpeting installed. Since the roofing company may not provide carpet installation services, the roofing company may provide the information that is received during the step 102. As a third example, a customer may send and email messages that requests information regarding the roofing company or the carpet installation company. The information may be received during the step 102.

In some embodiments of the method 100, information may not be received directly from customers. Rather, the information may be received from referral sources on behalf of customers or based on interactions between the referral sources and customers. For example, a telemarketing company may contact new businesses and forward information regarding the businesses that is received during the step 102. The telemarketing company may ascertain or guess what the needs of the businesses are from contacting the businesses, investigating the type or history of the businesses, etc.

In some embodiments, a device or entity implementing the method 100 may do via a Web site or other online or electronically accessible resource. The first party may provide the information received during the step 102 by accessing the Web site or resource, sending (e.g., emailing) the information to the Web site or resource, etc.

The information received during the step 102 from the first party may include a variety of information. For example, the information may include one or more of the following: information regarding contact between the first party and a customer; information regarding a customer's name, address, telephone number, contact information, industry designation or identifier, offered services, pricing, location, size, history, corporate structure, number of employees, standard industrial classification, or other characteristic etc.; a description of a customer; a description of actual, expected or perceived needs of a customer; a customer identifier; etc.

In some embodiments, the information received during the step 102 may form all or part of a customer lead or customer prospect designation. Different levels, amounts or types of information known about a customer may allow a customer to be designated as a lead, prospect, or some other designation. Alternatively, all information received during the step 102 may be used as a customer lead or to generate a customer lead. For example, a customer for which little information is known may be designated as a prospect while a customer for which more information is known may be designated as a lead.

During a step 104, a second party is identified to which at least a portion of the information received during the step 102 may be provided. In some embodiments, the second party may be a service provider.

In some embodiments, the first party may be allowed to select or identify the second party. The first party may provide information (e.g., name, email address, postal address, contact information) regarding the second party.

In some embodiments, the first party or the information received during the step 102 may identify a service needed by a customer. Thus, the step 104 may include identifying a party that can provide or otherwise perform the needed service.

In some embodiments, a party or device implementing the method 100 may maintain, store or have access to a list or database of service providers. During the step 104, the party or device may select one of the service providers or determine if any of them can provide services relevant to or of interest to the customer.

Selection of a service provider may be based on a characteristic of a customer received as part of the information received during the step 102. For example, a characteristic of a customer may be related to a type of property (e.g., apartment building, hotel, multifamily dwelling, single family dwelling, hospital, warehouse, industrial site, retail space, storage facility, office building, restaurant, park, shopping mall) owned or used by the customer. Based on the type of property, one or more service providers might be selected or otherwise identified that can provide services relevant to the property. A service provider that installs ovens, refrigerators, or other appliances may be relevant to an owner of an apartment building but not to an owner of a park. A service provider that provides landscape services may be relevant to both owners.

In some embodiments, the step 104 may be or include determining a characteristic associated with a customer based, at least in part, on the information received during the step 102 (which may include specific information regarding the characteristic); determining a service relevant to or otherwise associated with the characteristic; and identifying a party that can provide the service.

During a step 106, at least a portion of the information received from a first party during the step 102 is provided directly or indirectly to the second party identified during the step 104. The information provided to the second party may be in any form or format and include information other than the information received during the step 102. For example, information may be provided to the second party in or as part of an email message, instant message communication, FTP (File Transfer Protocol) transmission, XML (Extensible Markup Language) feed, beeper or pager signal, radio signal, telephone call, facsimile transmission, or other electronic signal or communication.

In some embodiments, the step 106 may be or include providing a notice to the second party regarding availability of at least a portion of information received during the step 102 and allowing the second party to retrieve, download, etc. at least a portion of the information, access the information via a Web site, database, or other resource, etc.

In some embodiments, the step 106 may be or include providing an electronic communication (e.g., email, beeper signal) that includes some or all of the information received during the step 102, data (e.g., link, domain name, Web site address) indicative of a location or resource (e.g., Web site, database) where the information can be accessed, retrieved from, etc., or information regarding receipt of the information during the step 102.

In some embodiments, a lead generated from or using the information regarding a customer received during the step 102 may be associated with the second party identified during the step 104 and the customer and/or between the second party and the information provided during the step 106. The second party may be allowed to access information regarding the lead, which may include information not provided to the second party initially during the step 106. For example, a lead that includes a description and/or name of the customer may be provided to the second party during the step 106. Additional information maybe provided to the second party at a later time of if the second party accesses a Web site, database or other resource that includes the additional information. In some embodiments, the second party identified during the step 104 may be the only party allowed to receive, retrieve or access the lead or information. The information received during the step 102 may be used to create multiple leads that are sent to multiple service providers, the second party identified during the step 104 being one of such service providers.

During a step 108, updated information regarding the customer is received directly or indirectly from the second party. The updated information may be received in any form or format, such as those previously discussed above. In some embodiments, the first party that provided the information received during the step 102 may or may not have access to the updated information received during the step 108 from the second party.

The second party may update information for a single customer during the step 108. Alternatively, the second party may update information for multiple customers during the step 108. Thus, information regarding one or more customers can be updated on an ad hoc or as a batch.

In some embodiments, a device or entity implementing the method 100 may conduct a Web site that the second party can access to obtain, provide and update information regarding a customer. The Web site may store the information and/or one or more databases related to the information. For example, information regarding one or more customers may be stored in a customer information database accessible by the second party.

Update information received during the step 108 may be or include updates to the information received during the step 102, additional information regarding the customer involved in the step 102, information regarding contact between the second party and the customer; information regarding a customer's name, address, telephone number, contact information, industry designation or identifier, offered services, pricing, location, size, history, corporate structure, number of employees, standard industrial classification, or other characteristic etc.; a description of a customer; a description of actual, expected or perceived needs of a customer; a customer identifier; etc. Furthermore, in some embodiments, the updated information may be or include information regarding a transaction (e.g., sale of a service) between a second party and a customer; information regarding a sale of services by the second party to the customer; information regarding contact between the second party and the customer; etc. For example, updated information may include information regarding services provided by the second party to the customer. The information may describe the value or price of the services, the start/end dates of the services, the amount of labor involved, the type of services provided, etc.

During a step 110, a determination is made regarding compensation owed by the second party. Compensation may be owed the first party the provided the information received during the step 102, a party implementing the method 100, a customer, and/or some other entity.

In some embodiments, a determination of the compensation may be dependent, in whole or in part, on the updated information received during the step 108. For example, the updated information may include information regarding a transaction between the second party and a customer. The compensation may be a percentage of the value or price of the transaction, a flat fee per transaction, or otherwise based on the transaction. Different compensation may be charged for different types of transactions, customers or service providers. Compensation may be based on a formula, model, contractually agreed upon rate, etc.

In some embodiments, the method 100 may include providing notification of the compensation determined during the step 110. The notification may be in any form or format (e.g., email message, facsimile transmission, radio signal) and may be sent to the first party or customer involved in the step 102, the second party involved in the steps 104, 106 and 108, and/or some other party or device. Information regarding compensation may be stored in a database and/or used to generate a report detailing compensation due, transactions between one or more service providers and customers, the times and dates of receiving information during the step 102 and/or the step 108, compensation rates, contact between a party and a customer, requests or inquiries received from a customer, etc. A notification sent regarding compensation may include the report.

In some embodiments, the method 100 may include receiving the compensation determined during the step 110 from the second party, allocating or providing some of the compensation to the first party, determining how much of the compensation determined during the step 110 should be provided to the first party, etc.

In some embodiments, the first party that provided the information regarding the customer received during the step 102 may provide additional information regarding the customer or one or more other customers. The new information may be used to create further leads that are sent to the second party identified during the step 104 or to one or more other parties. Thus, the method 100 facilitates referrals or exchanges of information between referral sources and service providers. Different service providers may receive different leads or information depending on the type of customer, what the needs the customer has or is expected to have, the actions or effort made by service providers upon previous receipt of leads or other information regarding customers, etc.

In some embodiments, the method 100 may include determining a characteristic of a customer involved in the step 102. Information regarding the characteristic may be received as part of the step 102 or may be inferred from the information received during the step 102. Alternatively, a party or device implementing the method 100 may conduct research, make inquiries, interact or communicate with the customer, etc. to determine the characteristic.

In some embodiments, a characteristic of a customer may be or include an identification or other description of property managed, owed, being developed, etc. by the customer; a current need for a service expressed by the customer; an expected need for a service of the customer; a description of at least one business activity conducted by the customer; a standard industry classification of the customer; a geographic location of the customer.

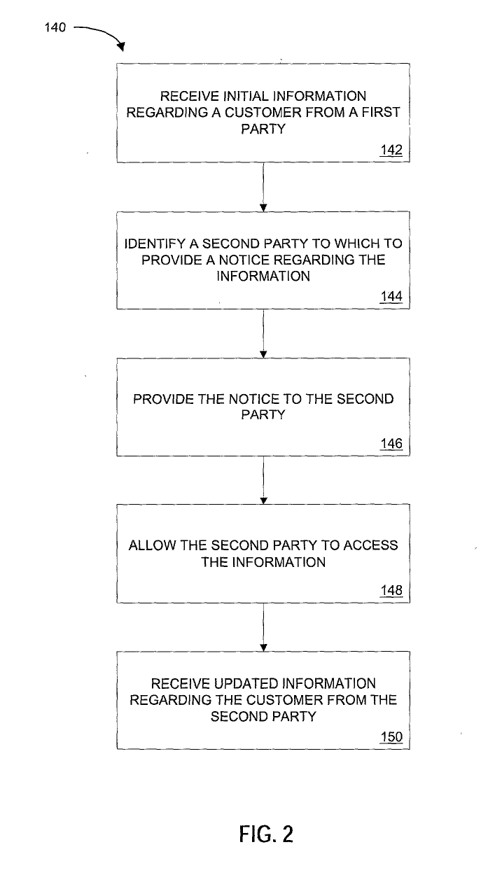

Reference is now made to FIG. 2, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a server, user device and/or another device, as will be discussed in more detail below. In some embodiments, the method 140 may include some or all of the variations discussed above in relation to the method 100. The method 140 is particularly suited for a coordinator or central resource (e.g., Web site, server) that receives information regarding customers and provides some or all of the information to one or more service providers.

Processing begins at a step 142 during which initial information regarding a customer is received from a first party. The step 142 is similar to the step 102 previously discussed above.

During a step 144, a second party is identified to which to provide a notice regarding the information received during the step 142. The step 144 is similar to the step 104 previously discussed above. In some embodiments, the step 144 may be or include one or more of the following: allowing the first party to select the second party from a plurality of service providers; allowing the first party to identify a service needed by the first customer and identifying a party that can provide the service; selecting the second party from a plurality of service providers; determining a service needed by the customer based on the initial information and identifying a party that can provide the service; receiving an identification of the second party from the first party; etc. Alternatively, in some embodiments, the step 144 may be or include determining a characteristic associated with the customer based, at least in part, on the initial information; and determining a service associated with the characteristic; and

identifying a party that can provide the service.

During a step 146, a notice is provided to the second party identified during the step 144 regarding the customer information received during the step 142. The step 146 is similar to the step 106 previously discussed above, however, only some, if any, of the information received during the step 142 is provided in the notice sent during the step 146. Thus, the notice provided during the step 146 may provide an indication of the existence of the information, or a lead created from the information, without providing any, or only a little, of the information itself. The notice provided during the step 146 may be in any format or format (e.g., email message, instant message communication, XML feed, or other electronic signal). The notice may include a description of the customer, a description of the information, information regarding the time and/or date the information was received during the step 142, information regarding when or how contact was made between the first party and the customer, an expiration date associated with the information, a priority level associated with the information (e.g., “This customer is looking to make a purchase within the next forty-eight hours), information regarding the first party (e.g., name, description, number of previous customer leads that led to sales) that provided the information, information (e.g., link, URL, Web site address, database entry, customer log) regarding the location of the information, an identifier associated with the information, etc.

In some embodiments, the step 146 may be or include one or more of the following: providing an electronic communication to the second party that includes the notice; providing an electronic communication to the second party that includes data indicative of a location of the notice; providing an email message to the second party indicative of a receipt of the initial information from the first party; providing an electronic communication to the second party indicative of a receipt of information regarding the customer from the first party; etc.

During a step 148, the second party identified during the step 144 is allowed to retrieve, receive or otherwise access some or all of the information received during the step 142. The second party may access the information by accessing a designated Web site and using a password or identifier associated with information to call up or retrieve the information from the Web site or a database, log, etc. associated with the Web site.

By using the steps 146 and 148, a party or device implementing the method 140 may monitor when the second party accesses the information during the step 148 after receiving the notice transmitted during the step 146. Thus, the party or device can monitor more easily and efficiently the second party's response to customer leads.

In some embodiments, the step 148 may be or include one or more of the following: allowing access by the second party to a Web site, database, log or other resource that includes the at least a portion of the initial information; allowing the second party to retrieve the at least a portion of the information from a resource indicated in the notice; allowing the second party to access a resource indicated in the notice; facilitating access by the second party to the at least a portion of the initial information via a Web site; etc.

During a step 150, a party or device implementing the method 140 may receive updated information regarding the customer involved in the step 142. The step 150 is similar to the step 108 previously discussed above.

In some embodiments, the method 140 may include determining compensation due from the second party and/or compensation due to the first party; providing a notification regarding the compensation to the second party, first party, customer or some other party or device; receiving compensation from the second party; providing compensation to the first party or the customer; determining or creating a report; providing some or all of the report to the second party, first party, customer or some other party or device; creating a lead from the information received during the step 142; receiving information regarding one or more additional customers from the first party; storing or maintaining a database, log, Web site or other resource that includes information regarding one or more service providers from which the second party can be selected; limiting access to the information received during the step 142, or one or more leads created from the information received during the step 142, to the second party identified during the step 144; etc., as previously discussed above.

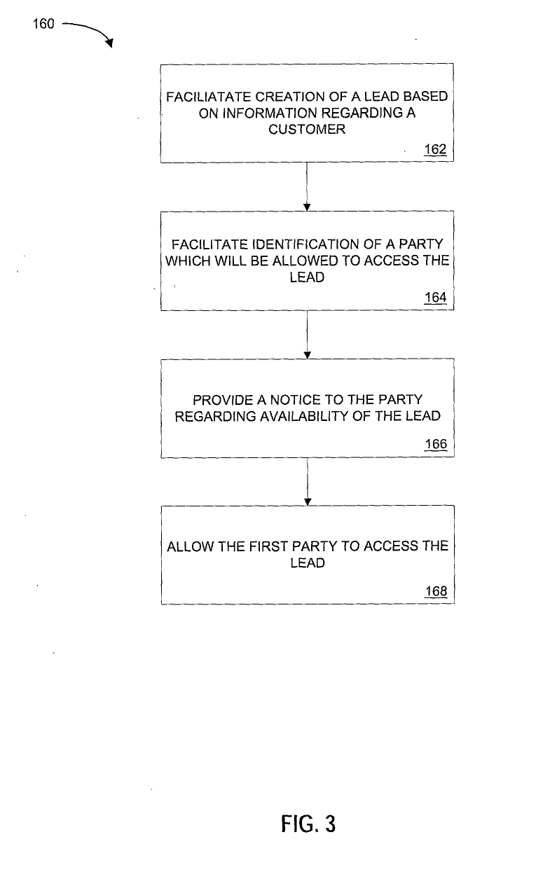

Reference is now made to FIG. 3, where a flow chart 160 is shown which represents the operation of a third embodiment of the present invention. The particular arrangement of elements in the flow chart 160 is not meant to imply a fixed order to the steps; embodiments of the present invention can be practiced in any order that is practicable. In some embodiments, some or all of the steps of the method 160 may be performed or completed by a server, user device and/or another device, as will be discussed in more detail below.

In some embodiments, the method 160 may include some or all of the variations discussed above in relation to the methods 100 and 140. The method 160 is particularly suited for a coordinator or central resource (e.g., Web site, server) that receives information regarding customers and provides some or all of the information to one or more service providers.

Processing begins at a step 162 during which creation of a lead based on information regarding a customer is facilitated. For example, a device or entity implementing the method 160 may host or operate a Web site via which a referral source can provide information regarding the customer, fill out an online form to supply customer information, respond to inquiries directed to receiving information about the customer, etc. The referral source or the Web site may control the order of entry of information, the type or amount of information provided, etc. In addition, the referral source or the Web site may control what constitutes a lead, what information is required for a lead, etc. The use of the term “lead” is not meant to imply any specific level, type, amount, etc. of information and should be construed broadly for purposes of the present invention and all of the claims that follow.

Facilitation of creation of a customer lead may occur in real time. That is, a lead may be created automatically as a referral source provides the information to a Web site or other resource. Alternatively, the customer lead may occur after the referral source has provided the information to the Web site or other resource. The Web site or other resource, or a device or person using the Web site or other resource, may process the information, request further information from the referral source, determine what information to use in the lead, etc. In addition, the Web site or resource may store, maintain or have access to information regarding one or more service providers to which the lead can be provided.

During a step 164, identification of at least one party that will be allowed to access the lead is facilitated. Using the previous example of the Web site, the Web site may select or otherwise identify the party based on the lead generated during the step 162. Alternatively, a referral source involved in the step 162 or which provided information used during the step 162 may name, select or designate a service provider. For example, if the customer lead created during the step 162 includes information indicating that the customer is an owner of an apartment building, a service provider that provides roofing, pool maintenance, appliance repair, painting or other services may be selected during the step 164 by the referral source or by the Web site.

During a step 166, a notice is provided to the party identified during the step 164. The step 166 is similar to the step 146 previously described above.

During a step 168, the party to which the notice is sent during the step 166 is allowed to receive, retrieve or otherwise access the lead. The step 168 is similar to the step 148 previously discussed above.

In some embodiments, the method 160 may include determining compensation due from a party and/or compensation due to a party; providing a notification regarding the compensation due to or from a party; receiving compensation from a party; providing compensation to a determining or creating a report; providing some or all of the report to a party; receiving information regarding one or more additional customers from one or more referral sources; storing or maintaining a database, log, Web site or other resource that includes information regarding one or more service providers; receiving information regarding a customer for use in the step 162; receiving updates to the lead created during the step 162 from the party identified during the step 164; limiting access to the lead created during the step 162; etc., as previously discussed above.

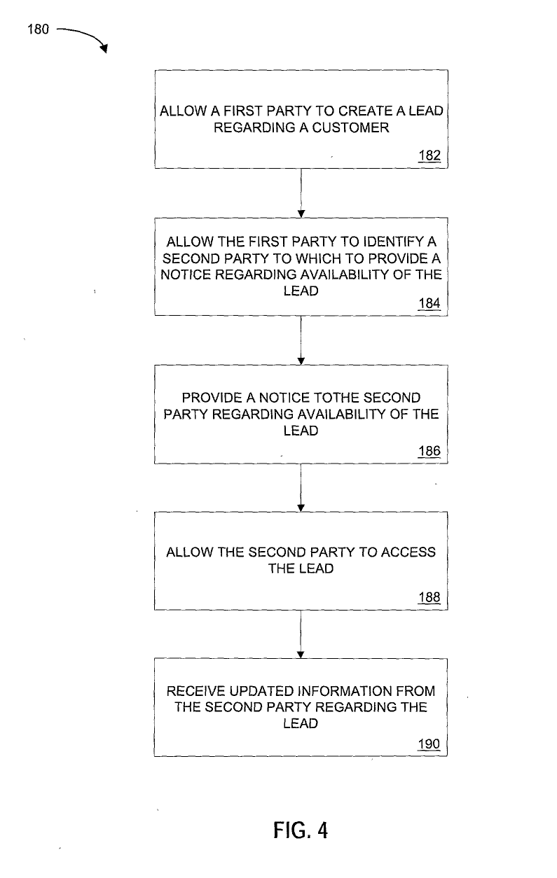

Reference is now made to FIG. 4, where a flow chart 180 is shown which represents the operation of a fourth embodiment of the present invention. The particular arrangement of elements in the flow chart 180 is not meant to imply a fixed order to the steps; embodiments of the present invention can be practiced in any order that is practicable. In some embodiments, some or all of the steps of the method 180 may be performed or completed by a server, user device and/or another device, as will be discussed in more detail below. In some embodiments, the method 180 may include some or all of the variations previously discussed above in relation to the methods 100, 140 and 160.

Processing begins at a step 182 during which a first party (e.g., referral source) is allowed to create a lead regarding a customer. The step 182 is similar to the step 162 previously discussed above. In some embodiments, the first party may access a Web site, database or other resource to provide information used in the lead and/or to create the lead itself (e.g., by filling out one or more forms via the Web site).

During a step 184, the party is allowed to select, designate or otherwise identify a second party to which to provide a notice regarding availability of the lead. The step 184 is similar to the steps 144 and 164 previously discussed above, with the first party that supplied the information received during the step 182 identifying the second party.

During a step 186, a notice regarding the availability of the lead is provided to the second party. The step 186 is similar to the steps 146 and 166 previously discussed above.

During a step 188, the second party is allowed to access the lead. The step 188 is similar to the steps 148 and 168 previously discussed above.

During a step 190, an entity or device implementing the method 180 receives updated information regarding the lead directly or indirectly from the second party. The step 190 is similar to the steps 108 and 150 previously discussed above.

In some embodiments, the method 180 may include determining compensation due from the second party and/or compensation due to the first party; providing a notification regarding the compensation to the second party, first party, customer or some other party or device; receiving compensation from the second party; providing compensation to the first party or the customer; determining or creating a report; providing some or all of the report to the second party, first party, customer or some other party or device; receiving information regarding one or more additional customers from the first party; storing or maintaining a database, log, Web site or other resource that includes information regarding one or more service providers from which the second party can be selected; limiting access to the information received during the step 182 or the lead created during the step 182 to the second party identified during the step 184; etc., as previously discussed above.

System

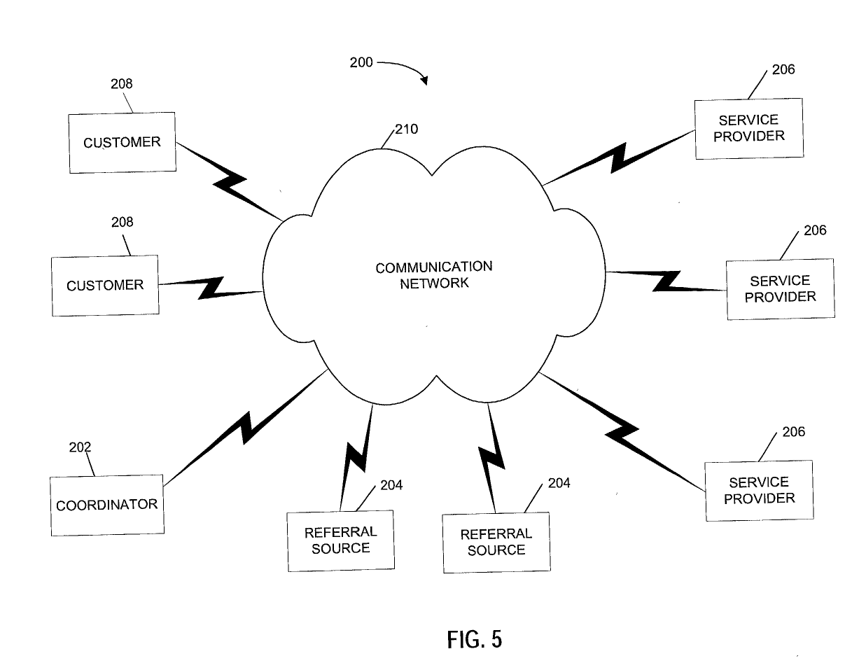

Now referring to FIG. 5, an apparatus or system 200 usable with the methods disclosed herein is illustrated. The apparatus 200 includes one or more coordinators (also referred to herein as coordinator devices or servers) 202 that may communicate directly or indirectly with one or more referral sources, 204, one or more service providers 206, and/or one or more customers 208 via a computer, data, or communications network 210. For purposes of further explanation and elaboration of the methods disclosed herein, the methods disclosed herein will be assumed to be operating on, or under the control of, the coordinator 202.

The coordinator 202 may implement or host a Web site, database or other online or electronic resource. A coordinator 202 can comprise or use a single device (e.g. a server or other computer), a networked set or group of devices, a workstation, etc. In some embodiments, a coordinator device 202 also may function as a database server. The use, configuration and operation of coordinator devices will be discussed in more detail below.

The referral sources 204 may be marketing representatives, salespeople, call center employees, telemarketers, etc. that interact with the coordinator 202 and customers 208, provide information regarding customers 208 or leads to the coordinator 202, access a Web site, database or other resource hosted or operated by the coordinator 202 to supply or create leads or customer information, etc. via the communication network 210. Customers may be using user or client devices such as a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database. Like a coordinator device, a referral source device can comprise or use a single device (e.g. a server or other computer), a networked set or group of devices, a workstation, etc. In some embodiments, a referral device also may function as a database server.

A service provider 206 may be any provider of services that may be of interest or use to a customer 208. The service providers 206 may provide information to the coordinator 202, referral sources 204 and/or customers 208 regarding the types of services the service providers can provider, the prices or costs associated with the services, the availability of the services, etc. A service provider device can comprise or use a single device (e.g. a server or other computer), a networked set or group of devices, a workstation, etc. In some embodiments, a service provider device also may function as a database server.

Many different types of implementations or hardware and/or software configurations can be used in the system 200 and with the methods disclosed herein and the methods disclosed herein are not limited to any specific hardware or software configuration for the system 200 or any of its components.

The communications network 210 might be or include the Internet, the World Wide Web, or some other public or private computer, cable, telephone, client/server, peer-to-peer, or communications network or intranet, as will be described in further detail below. The communications network 210 illustrated in FIG. 5 is meant only to be generally representative of cable, computer, telephone, peer-to-peer or other communication networks for purposes of elaboration and explanation of the present invention and other devices, networks, etc. may be connected to the communications network 210 without departing from the scope of the present invention. The communications network 210 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a referral source 204 may be connected directly to the coordinator 202 without departing from the scope of the present invention. Moreover, as used herein, communications include those enabled by wired or wireless technology.

In some embodiments, a suitable wireless communication network 210 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 5 may be equipped with a microchip transceiver that transmits and receives in a previously unused frequency band of 2.45 GHz that is available globally (with some variation of bandwidth in different countries). Connections can be point-to-point or multipoint over a current maximum range of ten (10) meters. Embodiments using Bluetooth technology may require the additional use of one or more receiving stations to receive and forward data between parties or devices in the system 200.

Although one coordinator 202, two referral sources 204, three service providers 206 and two customers 208 are shown in FIG. 5, any number of such devices or parties may be included in the system 200. The devices shown in FIG. 5 need not be in constant communication. For example, the coordinator 202 may communicate with a referral source 204 or service provider 206 only when such communication is appropriate or necessary.

Coordinator Device, Referral Source Device, and Service Provider Device

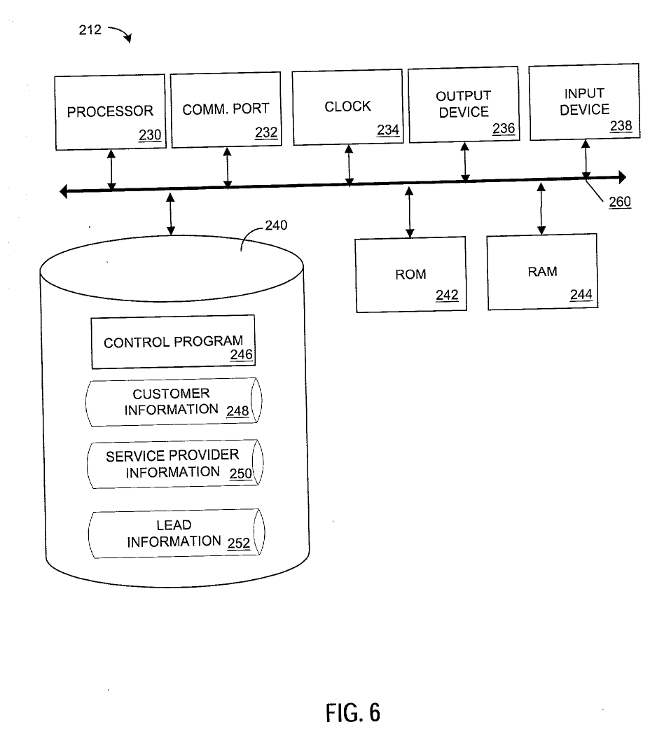

Now referring to FIG. 6, a representative block diagram of a server or controller 212 is illustrated. The server 212 may be used by the coordinator 202, a referral source 204 or a service provider 206.

The server 212 may include a processor, microchip, central processing unit, or computer 230 that is in communication with or otherwise uses or includes one or more communication ports 232 for communicating with user devices and/or other devices. Communication ports may include such things as local area network adapters, wireless communication devices, Bluetooth technology, etc. The server 212 also may include an internal clock element 234 to maintain an accurate time and date for the server 212, create time stamps for notices, information or other communications received or sent by the server 212, etc.

If desired, the server 212 may include one or more output devices 226 such as a printer, infrared or other transmitter, antenna, audio speaker, display screen or monitor, text to speech converter, etc., as well as one or more input devices 238 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 212 may include a memory or data storage device 260 to store information, software, databases, communications, device drivers, content, notices, leads, etc. The memory or data storage device 240 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 212 also may include separate ROM 242 and RAM 244.

The processor 230 and the data storage device 240 in the server 212 each may be, for example: (i) located entirely within a single computer or other computing device; or (ii) connected to each other by a remote communication medium, such as a serial port cable, telephone line or radio frequency transceiver. In one embodiment, the server 212 may comprise one or more computers that are connected to a remote server computer for maintaining databases.

A conventional personal computer or workstation with sufficient memory and processing capability may be used as the server 212. In one embodiment, the server 212 operates as or includes a Web server for an Internet environment. The server 212 preferably is capable of high volume transaction processing, performing a significant number of mathematical calculations in processing communications and database searches. A Pentium™ microprocessor such as the Pentium III™ microprocessor, manufactured by Intel Corporation may be used for the processor 230. Equivalent processors are available from Motorola, Inc., AMD, or Sun Microsystems, Inc. The processor 230 also may comprise one or more microprocessors, computers, computer systems, etc.

Software may be resident and operating or operational on the server 212. The software may be stored on the data storage device 240 and may include a control program 246 for operating the server, databases, etc. The control program 246 may control the processor 230. The processor 230 preferably performs instructions of the control program 246, and thereby operates in accordance with the present invention, and particularly in accordance with the methods described in detail herein. The control program 246 may be stored in a compressed, uncompiled and/or encrypted format. The control program 246 furthermore includes program elements that may be necessary, such as an operating system, a database management system and device drivers for allowing the processor 230 to interface with peripheral devices, databases, etc. Appropriate program elements are known to those skilled in the art, and need not be described in detail herein.

The server 212 also may include or store information regarding customers, customer devices, content, leads, notices, transactions, service providers, compensation, communications, etc. For example, information regarding one or more customers may be stored in a customer information database 248 for use by the server 212 or another device or entity. Information regarding one or more service providers may be stored in a service provider information database 250 for use by the server 212 or another device or entity and information regarding one or more leads may be stored in a lead information database 252for use by the server 212 or another device or entity. In some embodiments, some or all of one or more of the databases may be stored or mirrored remotely from the server 212

According to an embodiment of the present invention, the instructions of the control program may be read into a main memory from another computer-readable medium, such as from the ROM 242 to the RAM 244. Execution of sequences of the instructions in the control program causes the processor 230 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 230, communication port 232, clock 234, output device 236, input device 238, data storage device 240, ROM 242, and RAM 244 may communicate or be connected directly or indirectly in a variety of ways. For example, the processor 230, communication port 232, clock 234, output device 236, input device 238, data storage device 240, ROM 242, and RAM 244 may be connected via a bus 240.

While a specific implementation and hardware configuration for the server 212 have been illustrated, it should be noted that other implementations and hardware configurations are possible and that no specific implementation or hardware configuration is needed. Thus, not all of the components illustrated in FIG. 6 may be needed for a server implementing the methods disclosed herein. Therefore, many different types of implementations or hardware configurations can be used in the system 200 and the methods disclosed herein are not limited to any specific hardware configuration.

Customer Device

As mentioned above, a customer device may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a customer device ay have the same structure or configuration as the server 212 illustrated in FIG. 6 and include some or all of the components of the server 212.

Databases

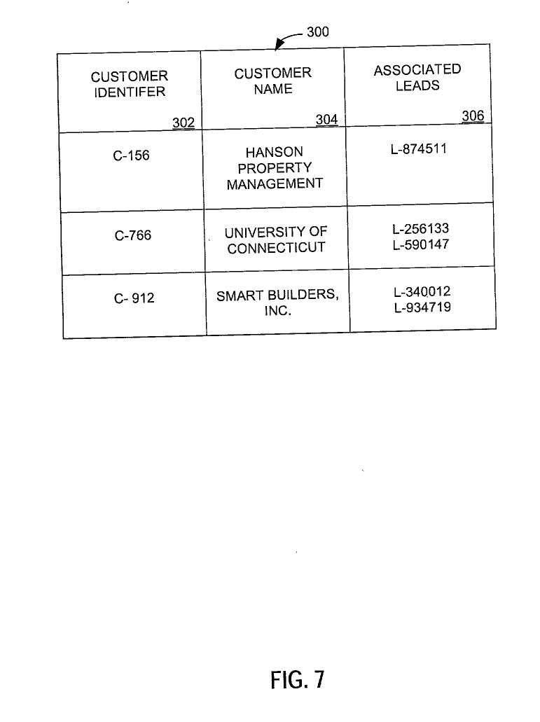

As previously discussed above, in some embodiments a server, user device, or other device may include or access a customer information database for storing or keeping information regarding one or more customers. One representative customer information database 300 is illustrated in FIG. 7.

The customer database 300 may include a customer identifier field 302 that may include codes or other identifiers for one or more customers, a customer description field 304 that may include names, contact information, or other descriptive information regarding the customers identified in the field 302, and an associated leads field 306 that may include codes or other identifiers for leads associated with the customers identified in the field 302. In some embodiments, information regarding one or more leads may be stored in or accessed from a lead information database.

Other or different fields also may be used in the customer information database 300. For example, in some embodiments a customer information database may include information regarding one or more characteristics of the customer, information regarding actual or perceived needs of the customer, information regarding one or more properties owned, managed or being built by the customer, information regarding when the customer information was added to the customer information database, information regarding what service providers, marketing agents, etc. have access to information for different customers, information regarding when contact with the customers was made and by whom, information regarding transactions involving the customers identified in the field 302, etc.

As illustrated by the customer information database 300 of FIG. 7, the customer identified as “C-156” in the field 302 is named “HANSON PROPERTY MANAGEMENT” and is associated with the lead identified as “L-874511”. The customer identified as “C-766” is the “UNIVERSITY OF CONNECTICUT” and is associated with the two leads identified as “L-256133” and “L-590147”.

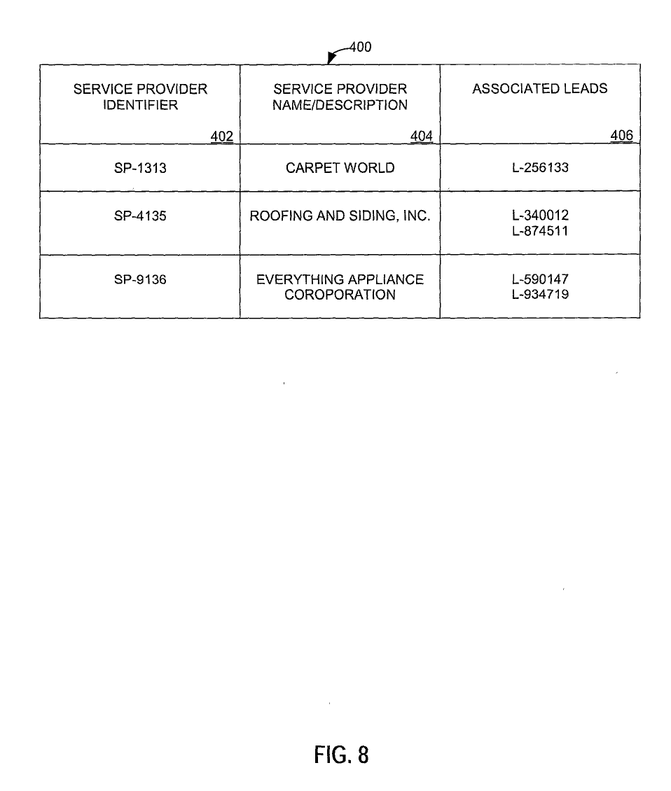

As previously discussed above, in some embodiments a server, user device, or other device may include or access a service provider information database for storing or keeping information regarding one or more service providers. One representative service provider information database 400 is illustrated in FIG. 8.

The service provider information database 400 may include a service provider identifier field 402 that may include codes or other identifiers for one or more service providers, a service provider description field 404 that may include name, contact, or other descriptive information regarding the service providers identified in the field 402, and an associated leads field 406 that may include codes or other identifiers for one or more leads associated with the service providers identified in the field 402.

Other or different fields also may be used in the service provider information database 400. For example, in some embodiments a service provider information database may include information regarding services provided by the service providers identified in the field 402, information regarding transactions involving customers and the service providers identified in the field 402, information regarding scheduling or availability of services provided by the service providers identified in the field 402, information regarding discounts, rebates, or other benefits or compensation available from the service providers identified in the field 402, etc.

As illustrated by the service provider information database 400 of FIG. 8, the service provider identified as “SP-1313” in the field 402 is “CARPET WORLD” and is associated with the lead identified as “L-256133”. The service provider identified as “SP-4135” in the field 402 is “ROOFING AND SIDING, INC.” and is associated with the two leads identified as “L-340012” and “L-874511”.

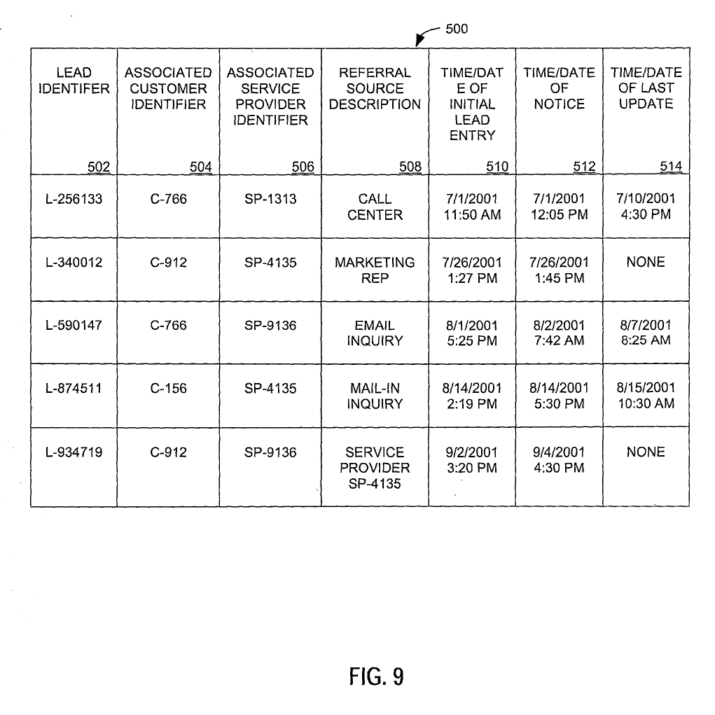

As previously discussed above, in some embodiments a server, user device, or other device may include or access a lead information database for storing or keeping information regarding one or more leads. One representative lead information database 500 is illustrated in FIG. 9.

The lead information database 500 may include a lead identifier field 502 that may include codes or other identifiers for one or more leads, an associated customer identifier field 504 that may include codes or other identifiers for one or more customers associated with the lead identified in the field 502, a service provider identifier field 506 that may include codes or other identifiers for one or more service providers associated with the leads identified in the field 502, a referral source description field 508 that may include names, category information, contact information, identifiers, etc. for referral sources associated with the leads identified in the field 502, a time/date of initial lead field 510 that may include time and date information regarding the creation or entry of the leads, or initial information for the leads, identified in the field 502, a time/date of notice field 512 regarding when notice of the leads identified in the field 502 were sent to the service providers identified in the field 506, and a time/date of last update field 514 that may include time/date information for when additions, changes, deletions or other updates where made to the leads identified in the field 502.

Other or different fields also may be used in the lead information database 500. For example, in some embodiments a lead information database may include information regarding all updates made to initial information, information regarding status of leads, information regarding contact or interaction with customers identified in the field 504 by the service providers identified in the field 506, information regarding transactions between the customers identified in the field 504 and the service providers identified in the field 506 that occur as a result of the leads identified in the field 502, information regarding compensation owed or provided by the service providers identified in the field 506 for the leads identified in the field 502, information regarding compensation owed or provided by the service providers identified in the field 506 as a result of transactions with customers based on the leads identified in the field 502, information regarding payments made or owed to the referral sources identified or otherwise described in the field 508, status information for the leads identified in the field 502, information regarding when the service providers identified in the field 506 accessed customer or lead information as a result of receiving a notice of the lead or that customer or lead information was available, etc.

As illustrated by the lead information database 500 of FIG. 9, the lead identified as “L-256133” in the field 502 is associated with the customer identified as “C-766” and the service provider identified as “SP-1313”. Information regarding the lead came from a “CALL CENTER” which may be or include an in-bound and/or out-bound telemarketing service or facility. The lead was created on Jul. 1, 2001, at 11:50 AM and a notice regarding the lead was sent to the service provider “SP-1313” on Jul. 1, 2001, at 12:05 PM. The service provider “SP-1313” updated the lead information on Jul. 10, 2001, at 4:30 PM. As illustrated by the entries for the lead identified as “L-340012”, updated information for the leads has not yet been received from the service provider identified as “SP-4135”.

As illustrated in the lead information database 500 of FIG. 9, referrals or lead information may come from many places (e.g., marketing representatives or salespeople, service providers, customer inquiries). In some embodiments, information regarding one or more referral sources may be stored or found in a referral source information database.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CDROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for facilitating multiparty communication regarding leads, comprising:
receiving initial information regarding a customer lead from a first party;
identifying a second party to which to provide at least a portion of the initial information;
providing at least a portion of said initial information to said second party;
receiving updated information regarding said customer lead from said second party; and
determining compensation owed by said second party based, at least in part, on said updated information.

2. The method of claim 1, wherein said receiving initial information regarding a customer lead from a first party includes at least one of the following:
allowing said first party to provide said initial information via a Web site;
receiving said initial information via an electronic communication;
receiving said initial information at a Web site accessed by said first party.

3. The method of claim 1, wherein said identifying a second party to which to provide said initial information includes at least one of the following:
allowing said first party to select said second party from a plurality of service providers; and
allowing said first party to identify a service needed by said customer and identifying a party that can provide said service.

4. The method of claim 1, wherein said identifying a second party to which to provide said initial information includes at least one of the following:
selecting said second party from a plurality of service providers;
determining a service needed by said customer based on said initial information and identifying a party that can provide said service; and
receiving an identification of said second party from said first party.

5. The method of claim 1, wherein said identifying a second party to which to provide said initial information includes:
determining a characteristic associated with said customer based, at least in part, on said initial information;
determining a service associated with said characteristic; and
identifying a party that can provide said service.

6. The method of claim 1, wherein said providing at least a portion of said initial information to said second party includes:
providing a notice to said second party regarding availability of at least a portion of said initial information; and
allowing said second party to retrieve at least a portion of said initial information.

7. The method of claim 1, wherein said providing at least a portion of said initial information to said second party includes:
providing a notice to said second party regarding availability of at least a portion of said initial information; and
allowing said second party access to said portion of said initial information via a Web site.

8. The method of claim 1, wherein said providing at least a portion of said initial information to said second party includes at least one of the following:
providing an electronic communication to said second party that includes said at least a portion of said initial information; and
providing an electronic communication to said second party that includes data indicative of a location of said at least a portion of said information.

9. The method of claim 1, wherein said providing at least a portion of said initial information to said second party includes at least one of the following:
providing an email message to said second party indicative of a receipt of said initial information; and
providing an electronic communication to said second party indicative of a receipt of information regarding said customer.

10. The method of claim 1, wherein said receiving updated information regarding said customer lead from said second party includes at least one of the following:
allowing said second party to provide said updated information via a Web site;
allowing said second party to access a Web site where said initial information is stored and update said initial information via said Web site;
receiving said updated information via an electronic communication; and
receiving said updated information at a Web site accessed by said second party.

11. The method of claim 1, wherein said determining compensation owed by said second party based, at least in part, on said updated information includes at least one of the following:
determining a value of a transaction between said second party and said customer;
determining existence of a transaction between said second party and said customer and basing said compensation, at least in part, on said transaction;
charging a fee to said second party for providing at least a portion of said initial information; and
charging a fee to said second party per transaction between said second party and said customer.

12. The method of claim 1, wherein said initial information includes at least one of the following:
information regarding contact between said first party and said customer;
a name of said customer;
contact information for said customer;
a postal address for said customer;
a description of said customer;
a characteristic of said customer; and
a customer identifier.

13. The method of claim 1, wherein said first party is a referral source.

14. The method of claim 1, wherein said second party is a service provider.

15. The method of claim 1, wherein said compensation is based on at least one of the following:
a fee per transaction conducted between said second party and said customer;
a percentage of revenue received by said second party as a result of a transaction between said second party and said customer; and
a fee per customer contacted by said second party.

16. The method of claim 1, wherein said updated information includes at least one of the following:
updated contact information for said customer;
updated postal address for said customer;
information regarding a transaction between said second party and said customer;
information regarding a sale of services by said second party to customer; and
information regarding contact between said second party and said customer.

17. The method of claim 1, further comprising:
storing information regarding a plurality of service providers, wherein said second party is one of said plurality of service providers.

18. The method of claim 17, further comprising:
creating a lead associated with said first customer and said second party, wherein said lead includes at least part of said initial information.

19. The method of claim 18, wherein none of said plurality of service providers other than said second party have access to said lead.

20. The method of claim 18, wherein said allowing said second party to access said initial information includes allowing said second party to access said lead.

21. The method of claim 1, further comprising:
receiving initial information regarding a new customer lead from said first party;
identifying a third party to which to provide said initial information regarding said new customer;
providing at least a portion of said initial information regarding said new customer lead to said third party; and
receiving updated information regarding said new customer lead from said third party.

22. The method of claim 1, further comprising:
receiving said compensation.

23. The method of claim 1, further comprising:
providing at least a portion of said compensation to said first party.

24. The method of claim 1, further comprising:
determining an amount of said compensation to provide to said first party.

25. The method of claim 1, further comprising:
determining a characteristic associated with said customer based, at least in part, on said information.

26. The method of claim 1, wherein said characteristic includes at least one of the following:
a description of property managed by said customer;
a description of property owned by said customer;
a description of property being developed by said customer;
a current need for a service expressed by said customer;
an expected need for a service of said customer;
a description of at least one business activity conducted by said customer; and
a geographic location of said customer.

27. The method of claim 1, wherein said first party does not have access to said updated information.

28. The method of claim 1, further comprising:
generating a report regarding said second party and at least one customer lead associated with said second party.

29. The method of claim 28, further comprising:
providing said report to said second party.

30. The method of claim 1, wherein said first party generates said initial information as a result of an interaction with said customer.

31. The method of claim 1, further comprising:
providing a notification of said compensation.

32. A method for facilitating multiparty communication regarding leads, comprising:
receiving initial information regarding a first customer from a first party;
identifying a second party to which to provide a notice regarding availability of at least a portion of said initial information;
providing said notice to said second party;
allowing said second party to access said at least a portion of said initial information; and
receiving updated information regarding said first customer from said second party.

33. The method of claim 32, wherein said identifying a second party to which to provide a notice regarding availability of at least a portion of said initial information includes at least one of the following:
allowing said first party to select said second party from a plurality of service providers;
allowing said first party to identify a service needed by said first customer and identifying a party that can provide said service;
selecting said second party from a plurality of service providers;
determining a service needed by said customer based on said initial information and identifying a party that can provide said service; and
receiving an identification of said second party from said first party.

34. The method of claim 32, wherein said identifying a second party to which to provide a notice regarding availability of at least a portion of said initial information includes at least one of the following:
determining a characteristic associated with said customer based, at least in part, on said, initial information; and
determining a service associated with said characteristic; and
identifying a party that can provide said service.

35. The method of claim 32, wherein said providing said notice to said second party includes at least one of the following:
providing an electronic communication to said second party that includes said notice;
providing an electronic communication to said second party that includes data indicative of a location of said notice;
providing an email message to said second party indicative of a receipt of said initial information; and
providing an electronic communication to said second party indicative of a receipt of information regarding said customer.

36. The method of claim 32, wherein said allowing said second party to access said at least a portion of said initial information includes at least one of the following:
allowing access by said second party to a Web site that includes said at least a portion of said initial information;
allowing said second party to retrieve said at least a portion of said information from a resource indicated in said notice; and
allowing said second party to access a resource indicated in said notice; and
facilitating access by said second party to said at least a portion of said initial information via a Web site.

37. The method of claim 32, further comprising:
storing information regarding a plurality of service providers, wherein said party is one of said plurality of service providers.

38. The method of claim 32, further comprising:
receiving initial information regarding a second customer from a third party;
identifying a fourth party to which to provide a notice regarding availability of at least a portion of said initial information regarding said second customer;
providing said notice regarding availability of at least a portion of said initial information regarding said second customer to said fourth party; and
allowing said fourth party to access said at least a portion of said initial information regarding said second customer.

39. The method of claim 32, further comprising:
receiving initial information regarding a second customer from said first party;
identifying a third party to which to provide a notice regarding availability of at least a portion of said initial information regarding said second customer;
providing said notice regarding availability of at least a portion of said initial information regarding said second customer to said third party; and
allowing said third party to access said at least a portion of said initial information regarding said second customer.

40. The method of claim 32, further comprising:
determining compensation owed by said second party based, at least in part, on said updated information.

41. The method of claim 40, further comprising:
receiving said compensation.

42. The method of claim 40, further comprising:
determining a least a portion of said compensation owed to said first party.

43. The method of claim 40, further comprising:
providing at least a portion of said compensation to said first party.

44. The method of claim 40, further comprising:
creating a lead based, at least in part, on said initial information.

45. The method of claim 44, wherein said identifying a second party to which to provide a notice regarding availability of at least a portion of said initial information comprises:
identifying a second party to provide a notice regarding availability of said lead.

46. The method of claim 44, wherein said allowing said second party to access said at least a portion of said initial information comprises:
allowing said second party to access said lead.

47. The method of claim 44, wherein said first party is one of a plurality of service providers and none of said plurality of service providers except said first party can access said lead.

48. A method for facilitating access to information regarding at least one customer, comprising:
facilitating creation of a first lead based, at least in part, on information regarding a customer;
facilitating identification of a first party which will be allowed to access said first lead;
providing a notice to said first party regarding availability of access to said first lead; and
allowing said first party to access said first lead.

49. The method of claim 48, further comprising:
creating a second lead based, at least in part, on said information;
identifying a second party to which to provide a notice regarding availability of said second lead;
providing said notice to said second party; and
allowing said second party to access said second lead.

50. The method of claim 48, further comprising:
receiving information regarding said customer.

51. The method of claim 50, wherein said first lead is based, at least in part, on said information.

52. The method of claim 48, further comprising:
receiving updates to said information from said first party.

53. The method of claim 52, further comprising:
determining compensation owed by said first party based, at least in part, on said updated information.

54. The method of claim 52, further comprising:
maintaining information regarding a plurality of service providers, wherein said first party is one of said plurality of service providers.

55. A method for facilitating access to information regarding at least one customer, comprising:
allowing a first party to create a lead regarding a customer;
allowing said first party to identify a second party to which to provide said lead;
providing notice to said second party regarding availability of said lead;
allowing said second party to access said lead; and
receiving updated information from said second party regarding said customer.

56. The method of claim 55, further comprising:
determining compensation owed by said second party based, at least in part, on said updated information.

57. A system for facilitating access to customer information, comprising:
a memory;
a communication port; and
a processor connected to said memory and said communication port, said processor being operative to:
facilitate creation of a first lead based, at least in part, on information regarding a customer;
facilitate identification of a first party which will be allowed to access said first lead;
provide a notice to said first party regarding availability of access to said first lead; and
allow said first party to access said first lead.

58. A computer program product in a computer readable medium for facilitating exchange of customer information, comprising:
first instructions for generating a lead based, at least in part, on information regarding a customer;
second instructions identifying a first party which will be allowed to access said lead;
third instructions for sending a notice to said first party regarding availability of access to said lead; and
fourth instructions for providing access said lead by said first party.
